(19) United States
(12) Patent Application Publication
(10) Pub. No.: US 2003/0101134 A1
(43) Pub. Date: May 29, 2003

(54) Method and system for trusted transaction approval

(76) Inventors: James C. Liu, Sunnyvale, CA (US); Thierry P. Violleau, Mountain View, CA (US); Bill M. Day JR., Mountain View, CA (US); John Wetherill, Los Gatos, CA (US)

Correspondence Address: ROSENTHAL & OSHA L.L.P., Suite 4550, 700 Louisiana, Houston, TX, 77002, US

(21) Appl. No.: 09/995,545

(22) Filed: Nov. 28, 2001

(51) Int. Cl. G06F 17/60

(52) U.S. Cl. 705/39

(57) ABSTRACT

A method for transaction approval includes submitting a transaction approval request from a transaction site to a clearing agency; submitting a user authorization request from the clearing agency to a user device; receiving a response to the user authorization request; and sending a response to the transaction approval request from the clearing agency to the transaction site. Another method for transaction approval includes submitting a transaction approval request from a transaction site to a clearing agency; determining whether a trusted transaction is elected; submitting a user authorization request from the clearing agency to a user device, if a trusted transaction is determined to be elected; receiving a response to the user authorization request from the user device, if the user authentification request was submitted; and sending a response to the transaction approval request from the clearing agency to the transaction site. A system for transaction approval includes a clearing agency for the transaction approval, the clearing agency having a function to request for user authorization; a network operatively coupled to the clearing agency; and a user device adapted to be operatively coupled to the network for trusted transaction approval.

### BACKGROUND OF INVENTION

1. Field of the Invention

The invention relates generally to systems for transaction approval.

2. Background Art

With the advent of computers and the Internet, many transactions are now conducted electronically. These electronic transactions permit a user to conduct transactions more efficiently and conveniently. Examples of electronic transactions include transactions conducted via computer networks, automated teller machines (ATM's), automated point-of-sale systems, and the like.

Transactions conducted via computer networks may encompass a wide range of subject matter, including exchanging information and data via a computer network popularly known as the Internet, for example, to make a purchase from a vendor on the network. ATM's typically permit users to conduct financial transactions (such as withdrawals, transfers, deposits, and the like) with a financial institution in an electronic manner. Automated point-of-sale systems may be used by merchants to permit a user to purchase products or services using the user's electronic account or credit card. These are but a few examples of the electronic transaction systems.

In any electronic transaction, it is important to verify that the user is authorized to access the account or to use the credit card. Therefore, electronic transaction systems typically require a user to provide proper identification to authenticate himself as a person authorized to make the proposed transaction or transactions. If the user fails to provide the requested identification data, the proposed transaction or transactions are not authorized and will not be processed. By way of example, in an ATM or debit card transaction, users are typically required to enter identification data (e.g., personal identification number, PIN) into the electronic transaction system for authentication. The identification data is then compared with data previously stored within the electronic transaction system. Authentication is satisfied when there is a match. Otherwise, the proposed transaction or transactions will not be allowed to proceed.

Similarly, in a point-of-sale system, a user may be required to provide some form of identification (e.g., a driver's license) to prove that the user is authorized to use the credit card. In addition, the merchant typically requires the user to sign the transaction slip; the signature serves as another measure of authentification. However, online or mail order transactions do not involve transaction slips or signatures. In addition, a user would disclose the account information over the network or by mail in such transactions. There are risks involved in transmitting such information. Thus, on-line and mail-order transactions involve more risk than the point-of-sale transactions.

To minimize the risk of credit card fraud in on-line or mail-order transactions, the American Express company has developed a one-time use system, in which a user may apply for a one-time use temporary account number which will expire within a specified period of time. Because the user only submits this temporary account number in an online transaction and the real account number is never submitted, the risk of “skimming” is minimized. Similarly, Visa has a “Verified Visa” program, which requires merchants to sign up with the program. In addition, each user is required to select a password for use in transactions at these “verified” merchant sites. In effect, the password adds another layer of security in online transactions at the participating merchant sites.

Even with these measures, the existing authentication methods are not always fool proof. The credit card and PIN may be stolen, and counterfeit cards may be forged from the stolen information. “Skimming” is a word used by credit/debit card thieves to describe the act of copying for illegal use of the magnetic information stored on a credit or debit card. A credit/debit card can be “skimmed” virtually any time the card is swiped through a reader or inserted into an ATM machine, by the user or by someone authorized by the user (e.g., a waiter at a restaurant). Because these machines are out of the possession and control of the user, they are not secure from skimming. A user takes some risk each time he uses an unsecured device, which may include any of the numerous private ATM machines now in convenient stores, shopping malls, gas stations, copy centers, and hotels.

It is desirable to have a transaction system which can reduce the possibility of fraud and yet be compatible with the existing transaction approval infrastructure.

### SUMMARY OF INVENTION

One aspect of the invention relates to methods for transaction approval. Some methods for transaction approval include submitting a transaction approval request from a transaction site to a clearing agency; submitting a user authorization request from the clearing agency to a user device; receiving a response to the user authorization request; and sending a response to the transaction approval request from the clearing agency to the transaction site. Other methods for transaction approval include submitting a transaction approval request from a transaction site to a clearing agency; determining whether a trusted transaction is elected; submitting a user authorization request from the clearing agency to a user device, if a trusted transaction is determined to be elected; receiving a response to the user authorization request from the user device, if the user authentification request was submitted; and sending a response to the transaction approval request from the clearing agency to the transaction site.

Another aspect of the invention relates to systems for transaction approval. One system for transaction approval includes a clearing agency for the transaction approval, the clearing agency having a function to request for user authorization; a network operatively coupled to the clearing agency; and a user device adapted to be operatively coupled to the network for trusted transaction approval. The clearing agency may include at least one server selected from the group consisting of a web server, an application server, and a database server.

Other aspects and advantages of the invention will be apparent from the following description and the appended claims.

### BRIEF DESCRIPTION OF DRAWINGS

FIG. 1 is a diagram of prior art transaction approval processes.

FIG. 2 is a diagram of transaction approval processes according to one embodiment of the invention.

FIG. 3 is a diagram of transaction approval processes according to another embodiment of the invention.

FIG. 4 is a diagram of an outline of a transaction approval system according to one embodiment of the invention.

FIG. 5 is a diagram of examples of server processes of a transaction approval system according to one embodiment of the invention.

FIG. 6 is a diagram of a transaction approval system according to one embodiment of the invention.

FIG. 7 illustrates an example of a data model for a trusted transaction approval system according to one embodiment of the invention.

### DETAILED DESCRIPTION

Embodiments of the invention relate to trusted transaction approval systems. “Trusted transactions” as used herein generally refer to transactions that involve the users in the approval process. By involving users in the approval process, the security of the transaction approval process is enhanced. The embodiments of the invention may comprise software architectures and business processes. These embodiments may be implemented as additional steps in the normal transaction authorization processes, and thus can be integrated into the existing infrastructure.

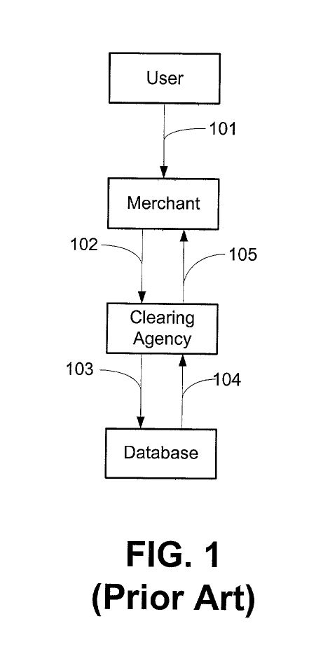

FIG. 1 illustrates prior art transaction approval processes. When a user initiates a purchase 101, the merchant at the transaction site submits an approval request to a clearing agency or bank 102. The “transaction site” as used herein generally refers to where the electronic transaction (purchase) initiates. This could be the store where an in-store purchase transaction takes place or the remote merchant site where an online or mail order transaction is handled. The clearing agency checks the transaction against a relevant account information database 103, which may or may not be housed within the clearing agency. The relevant account information database includes all relevant account information. In addition, the relevant account information database may also include a denial list (credit cards) or a PIN list (ATM and debit cards). Those skilled in the art will recognize that other types of relevant information may be included in the relevant account information database. If the requested transaction is not listed in the denial list or the PIN matches that in the PIN list, then an approval response is sent from the relevant account information database server to the clearing agency 104. A clearing agency may involve operators or may be completely automated on computers (servers), which may include an application server, a web server, and/or a database server. The clearing agency then relays the approval response to the merchant at the transaction site 105. This would conclude the transaction. In these prior art processes, the user is not involved in the approval process. Instead, the user only provides account information, and sometimes also the PIN, in the initial step 101. Because a user is not involved in these processes, an imposter or someone using a counterfeit card may defraud the system.

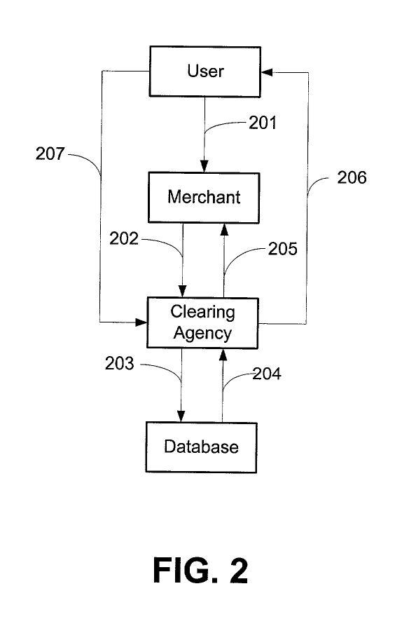

FIG. 2 illustrates trusted approval processes according to embodiments of the invention. These transaction processes require a clearing agency (which could comprise a server) or bank to request additional authorization from the user (“user authorization”) through a trusted communication channel to a user device 206 and 207. Trusted communication channels are typically pre-defined and saved with the account information. The “user devices” as used herein may be a computer, an internet appliance (e.g., a set-top box), a telephone, a mobile phone, a web phone, a pager, a personal digital assistant (PDA), a device specifically designed for such approval purpose, or any device with similar functionalities. The trusted communication may be, but is not restricted to, an on-line approval form using some browser not associated with the merchant, a short message to and from the user's email device or text pager, or a message to and from the user's phone, mobile phone, or web phone.

According to this embodiment, a user initiates a transaction as in the traditional fashion 201. The merchant then submits an approval request to the clearing agency 202. An application server or an operator at the clearing agency sends a query to a database server (“querying a database”), which may or may not be part of the clearing agency, to confirm that it is a valid account and that it is not on the denial list 203. The database server sends a response to the application server or the operator at the clearing agency 204. The clearing agency also sends an approval request to the user via a pre-defined method 206. Information on the predefined method may be stored within the clearing agency or in another database outside the clearing agency. Alternatively, the information on the predefined method may be stored on the credit card (e.g., a smart card) and submitted to the clearing agency together with the transaction approval request. If the information on how to obtain user approval is stored in the relevant account information database, then the clearing agency would send a request for approval to the user after receiving a response together with the necessary information on the pre-defined method from the database server. Otherwise, the clearing agency may send the request to the user prior to, simultaneously with, or after sending the request (query) to the database server. After the user receives the request from the clearing agency, the user may send a response (e.g., approve, deny, or other action) to the clearing agency 207. Alternatively, the user may ignore the request and allow a pre-defined default response to take effect. The clearing agency then forwards a response to the merchant according to the user response 205. This then completes the transaction.

As illustrated in FIG. 2, this embodiment only requires additional approval processes 206 and 207 to be overlaid on the existing authorization processes. There is no need to make significant changes to the existing infrastructure. Accordingly, embodiments of the present invention may also be implemented as an option in the existing approval system. In such an embodiment, a process is included to query whether a specific account has the trusted transaction feature activated. If the trusted transaction feature is elected, then the approval process will take advantage of this added security measure. If not, the approval process would proceed according to prior art methods.

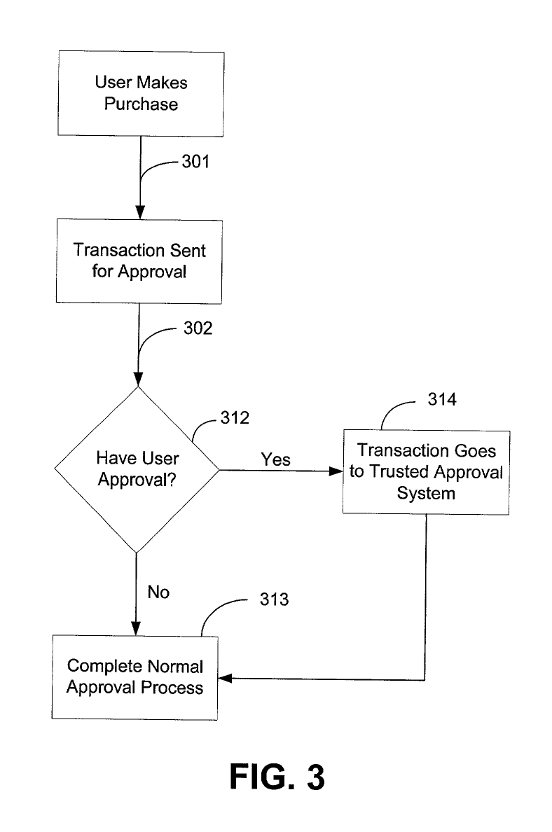

FIG. 3 illustrates an example of how an optional trusted approval system may be implemented. After a user makes a purchase 301, the transaction approval request is sent in 302 to process 312, which checks to see if the account has elected to use the trusted approval system (i.e., to engage the user in the approval process). The process 312 may, but does not have to, be implemented as part of the clearing agency (see FIG. 2). If the answer is yes from process 312, then the transaction is sent to a trusted approval system 314. The trusted approval system 314 would include user approval (see 206 and 207 in FIG. 2). If the answer from process 312 is no, then the process bypasses the trusted approval system 314 and goes directly to a normal approval process 313. The normal approval process 313 may be similar to those shown in FIG. 1.

To implement embodiments of the invention, a bank or credit card issuer, for example, would add the feature of trusted transactions to the credit card account when it issues a credit card to a customer. According to embodiments of the invention, the trusted transaction system may initially be configured to require personal approvals for all or some transactions, on-line or in-person. The card issuer may provide the user a choice of email alerts, email page, pager, mobile phone notification, or any other suitable means, or combination thereof. The user by default may have all these channels enabled, but may edit an information profile (on which preferred approval means selections are stored) later.

When the user goes on-line to make a purchase, the on-line merchant requests credit card name, address, number, and expiration date, which the user submits. Shortly after the merchant submits for approval of the transaction, the user's phone rings or pager goes off, or he may receive an email alerting him to the pending transaction, depending on the selections stored in the profile. The user at this point may use any one of his PC browser, phone, or mobile phone or other device to approve or deny the transaction. Alternatively, the user may ignore the request and let a default response take effect. Then, the merchant is notified of the results of the approval request. Embodiments of the invention are particularly suited for mail order and on-line transactions because the merchants do not need to process the transaction immediately, nor do the users need to approve the transaction immediately. The merchant can request the approval at his convenience and the user has time to peruse the request.

A similar transaction approval occurs in an in-person purchase transaction. When a user goes to a store and uses a credit card account having features of the invention, the merchant slides the card through a reader and awaits approval. Shortly, the user's phone or pager, for example, rings out an alert and the user is presented with an approval request. The user may select “approve,” “deny,” or other options. Shortly thereafter, the merchant receives the response from the clearing agency.

Embodiments of the invention may further include other features. For example, the trusted approval process may be waived if a transaction occurs at predefined points of sale or geographic areas. Similarly, rules may be setup such that only purchases over pre-selected dollar amounts will trigger the trusted transaction feature. Furthermore, the trusted approval system may include default settings, e.g., automatic denial after a preset time. These extra features can be best appreciated with the following example. A parent sends a child to college with a credit card for “emergency and school” use only. The account is configured so that all purchases made outside of the university require parental (primary card holder) approval and failure to approve any purchase within 60 seconds defaults to a denial. As an example, one autumn evening, while the parents are at home watching television, their internet set-top box (or other internet appliances) flashes an email alert on the screen. The parents check the email notice and see a request to approve a transaction at “Joe's Pizza & Beer” for $425. The parents ignore the request or select “deny.” Party is over for Junior.

As can be inferred from the above example, embodiments of the invention may be implemented such that the credit card user and the approver may or may not be the same person. For example, an employee may be issued a corporate credit card and the employer retains the right to approve any transaction or some transactions that meet certain criteria (e.g., over certain amounts, within or outside certain geographic areas, within or outside certain pre-defined time periods, etc).

In addition, trusted transaction approval systems of the invention may be linked with other functions. For example, when the approver has reasons to believe that an unlawful transaction is being conducted, the approver may send a denial response together with a notice to a security guard in the store or a proper law enforcement authority to arrest the perpetrator. Such a response from the user would be generally referred to as “fraud,” which is equivalent to a “denial” response with an additional request from the user to arrest the perpetrator. Thus, a user response may include “approval,” “denial,” “fraud,” or “default.” While an approval, a denial, or a fraud response requires a user to take an affirmative action, a default response requires no affirmative action from the user.

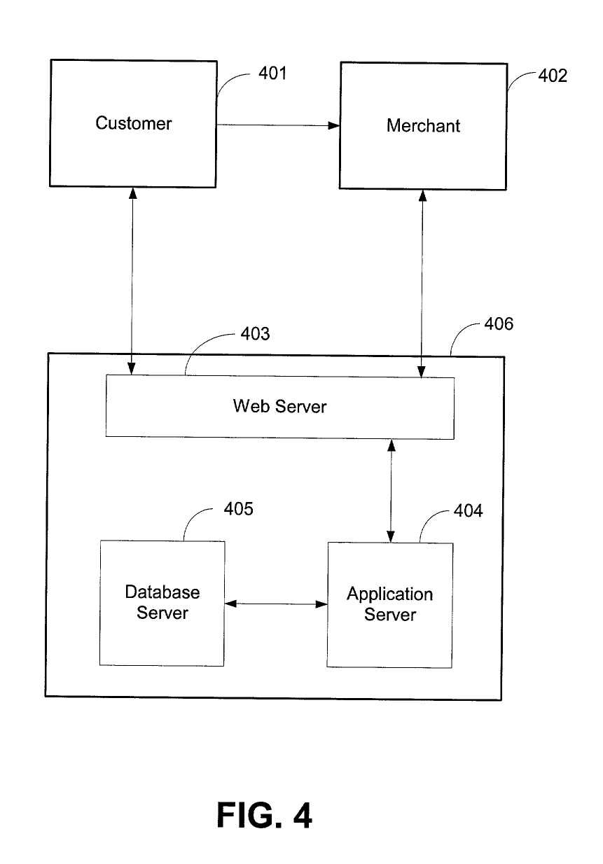

FIG. 4 illustrates an overview of one embodiment of the invention. According to this embodiment, the primary functions of the system may be delivered as a web service or other suitable implementation. Using a web service model, clients of any form (customer 401 or merchant 402) can connect via Hyper-Text Transfer Protocol (HTTP) or its secure form (HTTPS) to a web server 403. The web server 403 detects the type of request and provides content appropriately. The web service may be implemented on top of any suitable application server 404. The application server 404 may run on any platform (operating system), including an open-source platform such as Linux or an industry standard platform, such as Sun Microsystems's Java™ 2 Enterprise Edition (J2EE™) platform. Using a J2EE™ application server has an advantage in that the actual components are portable to any operating system running a compliant J2EE application server container. The application server 404 in turn interacts with a database server 405, which includes a relevant account information database. The relevant account information database may include account information and information on how to obtain user approval (the profile). As shown in FIG. 4, the web server 403, the application server 404, and the database server 405 together form an example of a clearing agency according to embodiments of the invention. The web server model as shown in FIG. 4, however, is not the only way to implement the present invention. Those skilled in the art will appreciate that other approaches such as email or other communication modes may be used.

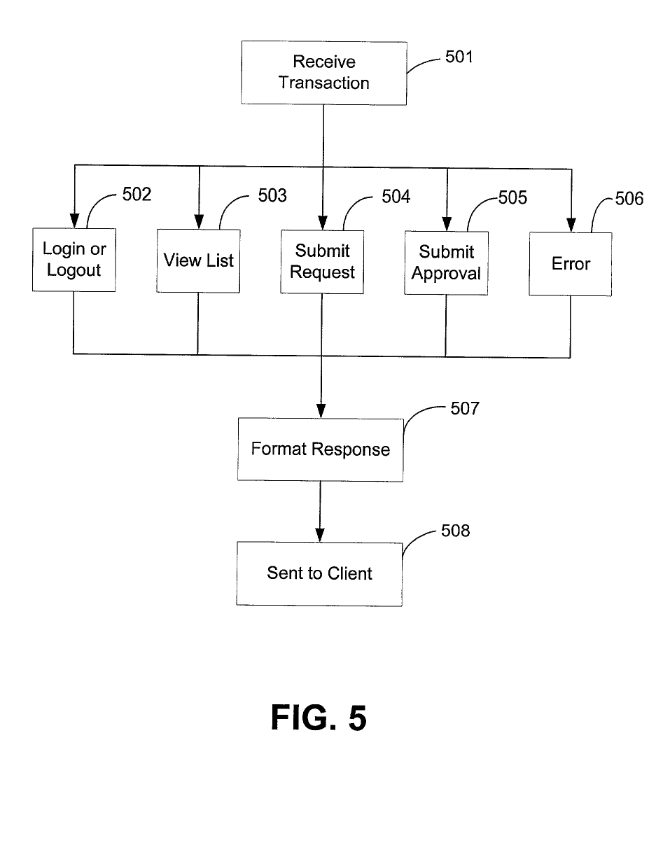

In addition to web servers, embodiments of the invention may rely on application servers to process most of the requests. FIG. 5 shows an example of the server-side applications: logging in/out 502, viewing or listing transactions 503, submitting request 504, submitting approval 505, and handling errors or bad requests 506. The server may retain the state of a connection within itself and automatically pass the requested action to the appropriate processes so that users need not manage this functionality explicitly. In this example, request processing is automatic in nature (i.e., requests are passed automatically among various functions in the server without the need for user intervention) and is guaranteed some response, including error handling (e.g., suggestion of possible causes of the error and recommended ways to alleviate the error).

As shown in FIG. 5, the server may include a process 501, which receives the transaction requests and forwards the requests to proper processes. A transaction request may require a user to log in. A login/logout function 502 authenticates the user to a session and creates a unique session for the user. The system may permit multiple users to login under the same account because there are situations when multiple users may sign-on simultaneously (e.g. primary user and spouse) and to access to the same set of data. Each session may remain unique, when multiple sessions are processed.

A primary function after login is to view any currently pending requests awaiting approval, or to view a history list of previous requests and/or approvals. This is handled by the view list process 503. For either current requests or a request history, the server delivers the content either in its entirety back to the user, or in logical increments of one or more transactions per request. For users who make approvals as well as requests, this function may also provide an interface which allows the user to query for current and historical approvals. The format may be a specifiable parameter and support formatted plain text in HTML, WML, plain tab delimited text, or other XML with provided schema.

A submit request function 504 is available for servers at other financial institutions to interface with this service. Because the application server may be hosted by a third party (e.g. a telecommunication company) other than the user and the bank or credit card issuer, it may be desirable to provide an authentication mechanism that authenticates each request from the sender of such a request. Ideally, this can be assured through some form of digitally signed request. For example, the server may implement this in an accepted eXtensible Markup Language (XML) encapsulation standard (e.g. ebXML) which supports digitally signed content. Once submitted, a request is processed and the response may be provided synchronously as to the state, which may indicate success in submitting into the system or an error with a corresponding error code and recommended course of action.

This example also includes a submit approval function 505, the primary use of which is to receive and process approvals. The approval process is similar to the request in the synchronicity of its response to the user; however, it has the unique capability to promote the transaction from a pending state to an approved state. Internally, the approval system may be implemented such that the approver (this could be the user/customer or someone designated by the user/customer) is abstracted from the account name so that approvals may be delegated. A single approver may approve requests for more than one account, and multiple approvers may approve either serially and/or in parallel and/or share joint tenancy each with full authority for approvals. The approval service provides a synchronous response to the approver which indicates a successful approval with a comment (e.g. success—sending to next approver), or error with a comment and a recommendation for corrective action. Each approval may also be logged and archived for historical record.

Requests to the web service which are not understood require error handling. The error handling service 506 is accessible from any function within the system, as well as from a direct user request. The implementation may support some levels of robust error checking, but with sufficient mechanisms in place such that it does not become a source for possible Denial of Service (DoS) attacks.

Once the server applications finish the processes, a response is formatted (process 507) and sent to the client (process 508).

The above are examples of the processes that may be included in the server-side applications. Other functionalities may also be included. For example, the system may include a functional component to provide for personalization (not shown). Personalization requires get and set methods on data fields such as a notification mechanism, default authorization models, and members of an account group who have authorization to use the system. The actual functions would depend on the data model implemented. The personalization features may be web-enabled through a standard desktop browser. Some limited functions may also be available via thin devices as well, and access into the system database may be partitioned securely such that unauthorized users cannot access data not delegated for their view.

In the embodiments of the invention, the application server may be based on any platform, such as a J2EE application server. An application server has the ability to handle HTTP requests from a front end web server and provides the required application server framework to implement the transactional components. Communications between the front-end web server and the application server may be handled transparently.

The server-side processes may be implemented in any suitable model, technology, or architecture. For example, it may be implemented using Sun Microsystems's Enterprise JavaBeans™ (EJB™) technology or other suitable models, technologies, or architectures. EJB™ server-side components simplify the development of middleware components that are transactional, scalable, and portable. Therefore, EJB™ servers reduce the complexity of developing middleware by providing automatic support for middleware services such as transactions, security, database connectivity, and more.

In the past, developers had to write and maintain transaction management code or rely on third-party transaction management systems, which are generally provided through proprietary, vendor-specific application programming interfaces (APIs). However, the use of EJB™ component-based technology in the construction of transactional software reduces the complexity of constructing such software. The EJB™ server handles the underlying transaction management details, so developers can focus on the business purpose of the objects and methods. Furthermore, because EJB™ technology is based on the Java™ programming language, components based on EJB™ technology can be deployed on any platform and operating system that supports the EJB™ standard. It should be noted that embodiments of the invention may also be implemented using models other than EJB™.

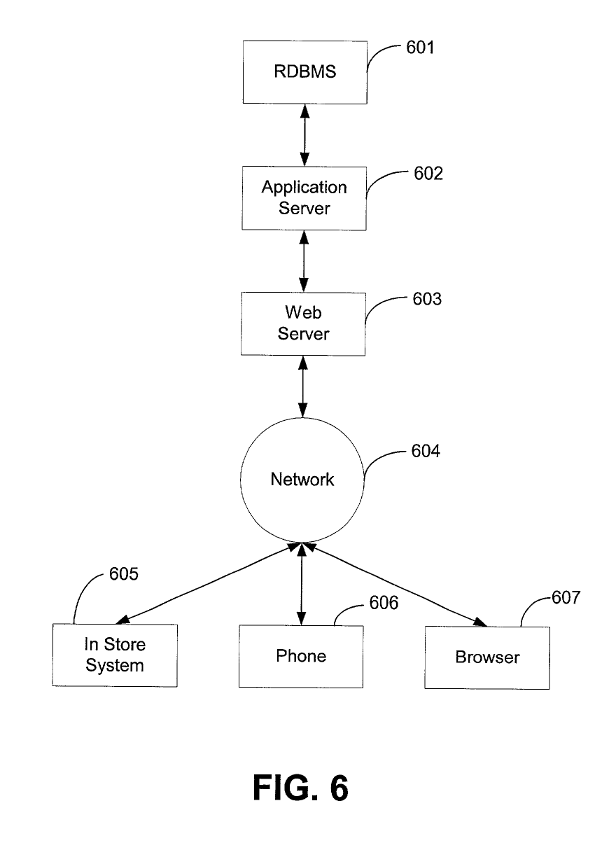

Embodiments of the invention are amenable to installation on a single physical host or on multiple hosts. For example, the entire application backend may be designed to run on a single application/web server, while the database server may run on a separate host. One embodiment of the software architecture is illustrated in FIG. 6. The network 604 as shown in this example may be the Internet, a virtual private network (VPN), a dedicated network, a radio/satellite link, or any similar communication link. The network 604 is an intermediary which connects client-side applications to server-side applications. The servers may include a web server 603, an application server 602, and a relational database management system (RDBMS) 601. The clients, as shown in this diagram, may include traditional desktop based browsers 607, or their equivalents on web-enabled mobile phones and PDAs 606, and merchant banking systems 605 which support transaction processing for merchants. These clients are examples for illustration only; other suitable clients or devices may be employed. For example, client functions may also be implemented in simpler formats (e.g., thin clients in question-and-answer formats) for communication with phones (land line or wireless phone) or pagers, or other similar devices with limited capabilities. Due to the limited capability of these mobile devices (user devices), the client applications usually run a limited-resource protocol, such as the wireless application protocol (WAP), which is an open-source protocol. Alternatively, these client applications may run on a limited-resource platform, such as Sun Microsystems' Java® 2 Micro Edition (J2ME), which is a Java runtime platform for small, embedded devices which support TCP/IP networking. Such user devices will be referred to as “limited-resource” devices.

In the embodiments where clients access the system via web browsers or their equivalents, the primary means of communication between clients and the web server would be HTTP or HTTPS. In this case, there may be a web server 603 to handle the communications between the clients 605-607 and the application server 602. The web server 603 and the application server 602 may be implemented on the same computer or on separate computers. The web server 603 accepts requests and may preprocess some of those requests and forward the requests in the correct format to the application server 602. Because most browsers and merchant traffic will come over an insecure internet, these communications may require Secure Sockets Layer (SSL) encryption and the standard X.509v3 digital certificate or other suitable encryption (e.g., Data Encryption Standard (DES), Triple DES, or Blowfish encryption algorithm) to secure the link between the client and the web server. Mobile phones and PDA's on the other hand, often use private networks provided by wireless carriers. These communications are somewhat secured against most types of casual listening. As such, if such a service is provided by a carrier, then encryption may have already been handled at a lower communication layer and may not be required at the application level. If not, other security measures may also be required.

In some embodiments of the invention, the application server-web server communication may be provided by some remote procedure call (RPC) mechanism. Various implementations are available. They may be implemented using proprietary marshalling libraries or using standard implementations such as Object Management Group's (OMG is a non-for-profit consortium that produces and maintains computer industry specifications for interoperable enterprise applications) Common Object Request Broker Architecture (CORBA) or Sun Microsystems' Java™ remote method invocation (RMI), or some other marshalling standard. These are vendor-independent architecture and infrastructure that computers use to interact over the networks. Access security may be implemented at the web server 603 as a first measure against outside hostile entities.

In some embodiments, the application server handles the bulk of the requests and performs the transaction processing. Some users may be permitted to access some processes, but not all. Therefore, additional security may be implemented at the server 602 level to grant different levels of access to different users.

In some embodiments of the invention, the backend database server 601 may be a relational database management system. Backend data access may be implemented using a standard protocol such as ODBC (open database connectivity) or Sun Microsystems' Java™ DataBase Connectivity (JDBC™) to a relational database. In embodiments that use a J2EE server, a JDBC compliant database will be sufficient. Sufficient bandwidth and resources are needed to insure that data read and writes do not become bottlenecks on performance. In some cases, there may be a need to implement caching on the application server which helps alleviate some of the communications bottlenecks with the database.

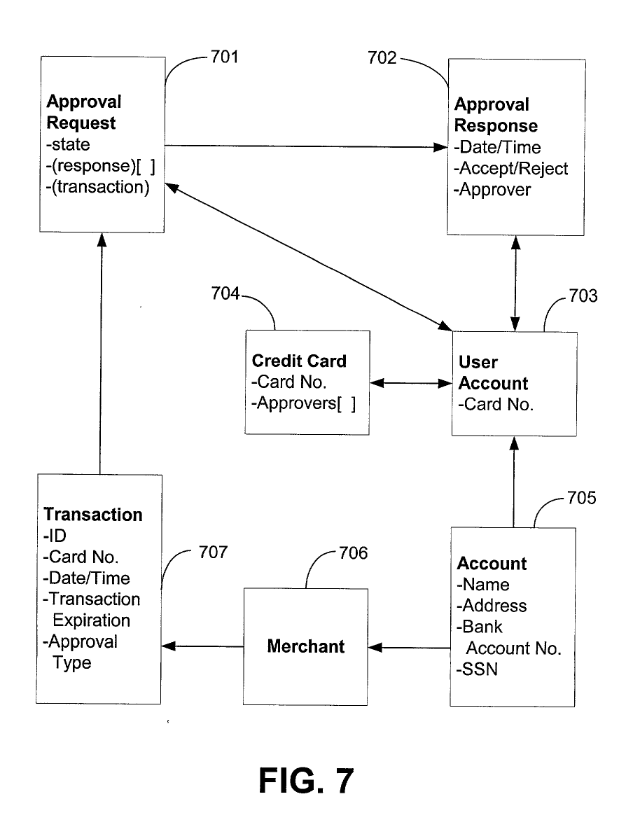

FIG. 7 illustrates an example of a data model that may be used in a system as shown in FIG. 2. In this example, there are seven major data components 701-707. The system may be used within banking services, whether it is intended to handle physical money, or only to handle the notification, approval or rejection of requests made for money into such a system. In other words, while this system does handle financial transactions, it does not need to directly handle currency exchange; it may be used as a component in the authorization by another system which actually handles the currency exchange.

Entities, whether an individual or corporation, may have some affiliation with a financial institution which will carry out the transaction. Whether this is a bank or other trusted establishment is not important and should not limit the present invention. What is important is that for a logical entity, there is the notion of an “account.” The account 705 may include information such as the name of the entity, the address, a unique account number, and some user ID number such as Social Security Number (SSN).

An individual or entity is typically required to have an account. However, the user account 703 requires some additional specifications (e.g., card number) beyond the scope of a generic account 705. The user account 703 is a way to uniquely identify and locate an entity or individual exclusive of any other entity. Associated with each account is also an access list, which contains references to what channels can access the account. For example, one might think of this as a list of credit cards which draw on the account or add liability to it.

A merchant account (equivalent of 705, not shown) is an instance of a regular bank account, but for a corporate entity rather than an individual. While a merchant account may still include a name, address and account number, the SSN is usually a Federal or State Tax payer ID number.

Each user account 703 may have a list of credit cards which can add liability to the user's account. Each credit card 704 may also have a list of approvers who will be notified when a transaction occurs and with whom the system seeks approvals. A user account 703 may have more than one credit card account associated with it and there needs to be a list of approvers for each card number (see 704).

Each transaction may be unique and be uniquely identified through some system generated ID. The merchant issuing the transaction needs to provide the credit card number, the amount for the transaction, the date/time of the transaction (see 707). In addition, in some embodiments, the merchant may also supply a time when the approval window expires on the transaction (not the expiration of the credit card) and some type of approval—whether synchronous or asynchronous (see 707). Along with the transaction of course is also a reference to the merchant account.

The application server may generate an approval request for each transaction which is submitted by the merchant. The request function may determine the user account or accounts which have authority over the card and inspect each user account for approver information. The system will then track the state of the request, the final response to the request, the transaction itself, and a list of approval responses (see 701).

Each approval request may generate multiple responses. Each response has the approver name, the date/time, and a result which was accepted or rejected (see 702). Users who log into the system will be presented a list of pending approval requests for each transaction. Their responses are then associated and stored with the approval request and notification made back to the merchant when the transaction completes or the transaction approval expiration is reached.

While the invention has been described with respect to a limited number of embodiments, those skilled in the art, having the benefit of this disclosure, will appreciate that other embodiments can be devised which do not depart from the scope of the invention as disclose herein. Accordingly, the scope of the invention should be limited only by the attached claims.

What is claimed is:

1. A method for transaction approval, comprising:
submitting a transaction approval request from a transaction site to a clearing agency;
submitting a user authorization request from the clearing agency to a user device;
receiving a response to the user authorization request; and
sending a response to the transaction approval request from the clearing agency to the transaction site.

2. The method of claim 1, wherein the user device comprises at least one selected from a telephone, a wireless phone, a personal digital assistant, a pager, an internet appliance, and a computer.

3. The method of claim 1, wherein the response to the user authentification request comprises one selected from the group consisting of approval, denial, fraud, and a default response.

4. The method of claim 1, wherein the submitting a user authentification request and the receiving a response to the user authorization are via wireless communications.

5. The method of claim 1, wherein the clearing agency comprises at least one server selected from the group consisting of an application server, a web server, and a database server.

6. The method of claim 5, wherein the database server comprises a database having therein information on a selected manner by which to submit the user authentification request.

7. The method of claim 6, wherein the database is a relational database.

8. The method of claim 6, further comprising querying a database for the selected manner by which to submit the user authentification request.

9. A method for transaction approval, comprising:
submitting a transaction approval request from a transaction site to a clearing agency;
querying a database for a selected manner by which to submit a user authentification request;
submitting the user authorization request from the clearing agency to a user device;
receiving a response to the user authorization request; and
sending a response to the transaction approval request from the clearing agency to the transaction site.

10. A method for transaction approval, comprising:
submitting a transaction approval request from a transaction site to a clearing agency;
determining whether a trusted transaction is elected;
submitting a user authorization request from the clearing agency to a user device, if a trusted transaction is determined to be elected;
receiving a response to the user authorization request from the user device, if the user authentification request was submitted; and
sending a response to the transaction approval request from the clearing agency to the transaction site.

11. The method of claim 10, wherein the user device comprises at least one selected from the group consisting of a telephone, a wireless phone, a personal digital assistant, a pager, an internet appliance, and a computer.

12. A system for transaction approval, comprising:
a clearing agency for the transaction approval, the clearing agency having a function to request for user authorization;
a network, operatively coupled to the clearing agency; and
a user device adapted to be operatively coupled to the network for trusted transaction approval.

13. The system of claim 12, wherein the clearing agency comprises at least one server selected from the group consisting of an application server, a web server, and a database server.

14. The system of claim 12, wherein the user device comprises one selected from the group consisting of a wireless phone, a personal digital assistant, an internet appliance, and a computer.

15. The system of claim 12, wherein the user device comprises a limited-resource device.

16. The system of claim 12, wherein the network comprises one selected from the group consisting of Internet, a virtual private network, a telephone network, a radio link, a satellite link, and a private network.

17. The system of claim 12, further comprising a machine at a transaction site operatively coupled to the network.

18. The system of claim 17, wherein the machine comprise one selected from the group consisting of an automatic teller machine, a credit card reader, and a debit card reader.

19. A system for transaction approval, comprising:
a clearing agency for the transaction approval, the clearing agency having a function to request for user authorization;
means for communication, operatively coupled to the clearing agency; and
means for user authorization, adapted to be operatively coupled to the means for communication.

20. The system of claim 19, wherein the clearing agency comprises at least one server selected from the group consisting of an application server, a web server, and a database server.

21. The system of claim 19, wherein the clearing agency comprises a function to determine whether a trusted transaction is elected.

22. The system of claim 19, further comprising a machine at a transaction site, the machine being operatively coupled to the means for communication.

23. The system of claim 22, wherein the machine is one selected from the group consisting of an automatic teller machine, a credit card reader, and a debit card reader.
